(19) United States
(12) Patent Application Publication
(10) Pub. No.: US 2014/0039128 A1
(43) Pub. Date: Feb. 6, 2014

(54) RADIATION-CURABLE PRESSURE-SENSITIVE ADHESIVE LAYER, AND RADIATION-CURABLE PRESSURE-SENSITIVE ADHESIVE SHEET

(71) Applicant: NITTO DENKO CORPORATION, Osaka (JP)

(72) Inventors: Kiyoe Shigetomi, Osaka (JP); Shou Takarada, Osaka (JP); Masahiko Ando, Osaka (JP); Katsuhiko Kamiya, Osaka (JP); Takahiro Nonaka, Osaka (JP); Shinya Yamamoto, Osaka (JP)

(73) Assignee: NITTO DENKO CORPORATION, Osaka (JP)

(21) Appl. No.: 13/954,329

(22) Filed: Jul. 30, 2013

(30) Foreign Application Priority Data
Jul. 31, 2012 (JP) 2012-169994
Mar. 5, 2013 (JP) 2013-043195

(51) Int. Cl. C09J 7/02; C09J 133/14

(52) U.S. Cl. CPC C09J 7/0217; C09J 133/14
USPC 525/303

(57) ABSTRACT

An object of the present invention is to provide a radiation-curable pressure-sensitive adhesive layer that satisfies both reworkability and adhesion reliance. Further, another object of the present invention is to provide a pressure-sensitive adhesive sheet containing the radiation-curable pressure-sensitive adhesive layer. The invention relates to a radiation-curable pressure-sensitive adhesive layer, which has an adhesive strength of 1.0 N/20 mm or less before radiation curing and an adhesive strength of 3.0 N/20 mm or more after radiation curing, and a peeling adhesive strength of 40.0 N/(20 mm×20 mm) or less before radiation curing, to an acrylic plate.

### BACKGROUND OF THE INVENTION

### Technical Field

The present invention relates to a radiation-curable pressure-sensitive adhesive layer excellent in reworkability and adhesion reliance, and also relates to a radiation-curable pressure-sensitive adhesive sheet having a support and the radiation-curable pressure-sensitive adhesive layer formed on at least one side of the support.

### BACKGROUND ART

Recently, image display devices such as a liquid crystal display (LCD) and input devices using such image display devices in combination with touch panels have been widely used in various fields. Among them, electrostatic capacity type touch panels are becoming popular rapidly from its functionality.

In these image display devices and input devices, an optical member and the like are bonded to such devices with a pressure-sensitive adhesive layer interposed therebetween, and a variety of pressure-sensitive adhesive layers have been proposed (for example, see Patent Document 1 to 3).

A high tackiness is required for such a pressure-sensitive adhesive layer. On the other hand, in a pressure-sensitive adhesive layer having a high tackiness, in the case where defects such as wrong position for bonding and inclusion of foreign materials in the bonding surface occur when the members are bonded mutually, the pressure-sensitive adhesive layer that was formed once might not be able to be easily peeled off or an adhesive residue might remain in the member even if such a pressure-sensitive adhesive layer could be peeled off. The member having such bonding defects had to be discarded, but since optical members used for image display devices or input devices are sometimes members with high price, it has been desired to peel off the pressure-sensitive adhesive layer and reuse the member even if the defect in the bonding as described above occurs. Therefore, not only high tackiness but also high repeelable property (reworkability) is required for the pressure-sensitive adhesive layer.

### PRIOR ART DOCUMENTS

### Patent Documents

Patent Document 1: JP-A-2003-238915
Patent Document 2: JP-A-2003-342542
Patent Document 3: JP-A-2004-231723

### SUMMARY OF THE INVENTION

### Problems to be Solved by the Invention

However, if the adhesive strength of the pressure-sensitive adhesive layer is decreased so as to improve reworkability, insufficient mutual bonding of the members is caused to result in poor adhesion reliance. Adversely, if the adhesive strength of the pressure-sensitive adhesive layer is increased so as to improve the adhesion reliance, the reworkability becomes poor. Thus, it is difficult to establish compatibility between reworkability and adhesion reliance.

Accordingly, an object of the present invention is to provide a radiation-curable pressure-sensitive adhesive layer that satisfies both reworkability and adhesion reliance. Further, another object of the present invention is to provide a pressure-sensitive adhesive sheet containing the radiation-curable pressure-sensitive adhesive layer.

### Means for Solving the Problems

As a result of intense investigations to solve the problems, the inventors have made the invention, based on the finding that the objects are achieved with a radiation-curable pressure-sensitive adhesive layer described below.

The invention relates to a radiation-curable pressure-sensitive adhesive layer, which has an adhesive strength of 1.0 N/20 mm or less before radiation curing and an adhesive strength of 3.0 N/20 mm or more after radiation curing, and a peeling adhesive strength of 40.0 N/(20 mm×20 mm) or less before radiation curing, to an acrylic plate.

The radiation-curable pressure-sensitive adhesive layer is preferably formed from a radiation-curable pressure-sensitive adhesive comprising a base polymer and a polyfunctional monomer.

In the radiation-curable pressure-sensitive adhesive layer, the base polymer is preferably a (meth)acryl-based polymer and the polyfunctional monomer is preferably a polyfunctional monomer having an ether bond and at least two radically polymerizable functional groups with a carbon-carbon double bond in the molecule.

In the radiation-curable pressure-sensitive adhesive layer, the content of the polyfunctional monomer is preferably 0.1 to 50 parts by weight based on 100 parts by weight of the base polymer.

The invention also relates to a radiation-curable pressure-sensitive adhesive sheet having a support and the radiation-curable pressure-sensitive adhesive layer formed on at least one side of the support.

In the radiation-curable pressure-sensitive adhesive sheet, the support is preferably an optical member and the pressure-sensitive adhesive sheet is preferably a pressure-sensitive adhesive optical member having a pressure-sensitive adhesive layer on at least one side of the optical member.

### Effect of the Invention

Since the radiation-curable pressure-sensitive adhesive layer of the present invention has an adhesive strength of 1.0 N/20 mm or less and a peeling adhesive strength of 40.0 N/(20 mm×20 mm) or less to an acrylic plate before radiation curing, when, for example, bonding is performed at wrong position or foreign materials enter into the bonding surface, the radiation-curable pressure-sensitive adhesive layer can be easily peeled off, and an adherend such as an optical member can be reused. On the other hand, since the adhesive strength to an acrylic plate after radiation curing is 3.0 N/20 mm or more, the adherend can be firmly bonded mutually after radiation curing, thereby to impart excellent adhesion reliance.

In the invention, for example, it is possible to exhibit the adhesive strength by forming a radiation-curable pressure-sensitive adhesive layer with use of a radiation-curable pressure-sensitive adhesive containing a base polymer and a polyfunctional monomer, wherein compatibility between the base polymer and the polyfunctional monomer is low to the extent not to impair the transparency. Since the compatibility between the base polymer and the polyfunctional monomer is low to the extent not to impair the transparency, the polyfunctional monomer in the radiation-curable pressure-sensitive adhesive layer before radiation curing is unevenly distributed in the vicinity of the surface of the radiation-curable pressure-sensitive adhesive layer to form an adhesion inhibitory layer. Thus, it is supposed that the adhesive strength is reduced and the reworkability becomes excellent. On the other hand, after radiation curing, it is supposed that the polyfunctional monomer distributed in the vicinity of the surface is crosslinked to improve the adhesive strength, which makes it possible to impart excellent adhesion reliance.

### BRIEF DESCRIPTION OF THE DRAWINGS

FIG. 1 (a) is a sectional view showing an instrument used in a peeling adhesive strength test, FIG. 1(b) is a view seen from below of the instrument used in the peeling adhesive strength test;

FIG. 2 is a view illustrating a method for the peeling adhesive strength test; and

FIG. 3 is a view showing an example of an electrostatic capacity type touch panel wherein the radiation-curable pressure-sensitive adhesive layer or radiation-curable pressure-sensitive adhesive sheet of the invention is used.

### MODE FOR CARRYING OUT THE INVENTION

### 1. Radiation-Curable Pressure-Sensitive Adhesive Layer

The radiation-curable pressure-sensitive adhesive layer of the invention has a feature that the radiation-curable pressure-sensitive adhesive layer has an adhesive strength of 1.0 N/20 mm or less before radiation curing, an adhesive strength of 3.0 N/20 mm or more after radiation curing, and a peeling adhesive strength of 40.0 N/(20 mm×20 mm) or less with respect before radiation curing, to an acrylic plate.

The radiation-curable pressure-sensitive adhesive layer of the invention has an adhesive strength of 1.0 N/20 mm or less, preferably less than 1.0 N/20 mm, more preferably 0.8 N/20 mm or less, and furthermore preferably 0.5 N/20 mm or less to an acrylic plate before radiation curing. The lower limit of the adhesive strength with respect to an acrylic plate before radiation curing is not particularly limited, but is preferably 0.01 N/20 mm or more. The adhesive strength of 1.0 N/20 mm or less with respect to an acrylic plate before radiation curing is preferred because the reworkability is excellent.

In addition, the radiation-curable pressure-sensitive adhesive layer has an adhesive strength of 3.0 N/20 mm or more, preferably 3.2 N/20 mm or more, more preferably 5.0 N/20 mm or more, and furthermore preferably 8.0 N/20 mm or more to an acrylic plate after radiation curing. The upper limit of the adhesive strength to an acrylic plate after radiation curing is not particularly limited, but is preferably 30 N/20 mm or less. The adhesive strength of 3.0 N/20 mm or more to an acrylic plate after radiation curing is preferred because the adhesion reliance to an adherend is excellent.

The adhesive strength before and after radiation curing is measured as follows.

A laminate (20 mm width) of a 25 μm thick polyethylene terephthalate (PET) film and the radiation-curable pressure-sensitive adhesive layer of the invention is prepared and used as a test piece. The pressure-sensitive adhesive surface of the radiation-curable pressure-sensitive adhesive layer of the laminate is bonded to an acrylic plate of 2 mm thickness.

### (Adhesive Strength Before Curing)

After bonding the radiation-curable pressure-sensitive adhesive layer to the acrylic plate, the laminate is allowed to stand at 23° C. for 30 minutes and one end of the laminate of the radiation-curable pressure-sensitive adhesive layer and the PET film is peeled off at a rate of 300 mm/minute in a peeling direction of 180° and an adhesive strength (resistance strength) (unit: N/20 mm) to the adherend at that time is measured.

(Adhesive Strength after Curing)

The radiation-curable pressure-sensitive adhesive layer is bonded to the acrylic plate, cured with a radiation of 3000 mJ/cm², allowed to stand at 23° C. for 30 minutes, and one end of the laminate of the radiation-curable pressure-sensitive adhesive layer and the PET film is peeled off afterwards at a rate of 300 mm/minute in a peeling direction of 180° and an adhesive strength (resistance strength) (unit: N/20 mm) to the adherend at that time is measured.

The peeling adhesive strength before radiation curing is 40.0 N/(20 mm×20 mm) or less, preferably 35.0 N/(20 mm×20 mm) or less, more preferably 30.0 N/(20 mm×20 mm) or less, and furthermore preferably 25.0 N/(20 mm×20 mm) or less. The lower limit of the peeling adhesive strength before radiation curing is not particularly limited, but is preferably 1.0 N/(20 mm×20 mm) or more. The peeling adhesive strength of 40.0 N/(20 mm×20 mm) or less to the acrylic plate before radiation curing is preferred because the reworkability is excellent.

The peeling adhesive strength before radiation curing is measured as follows.

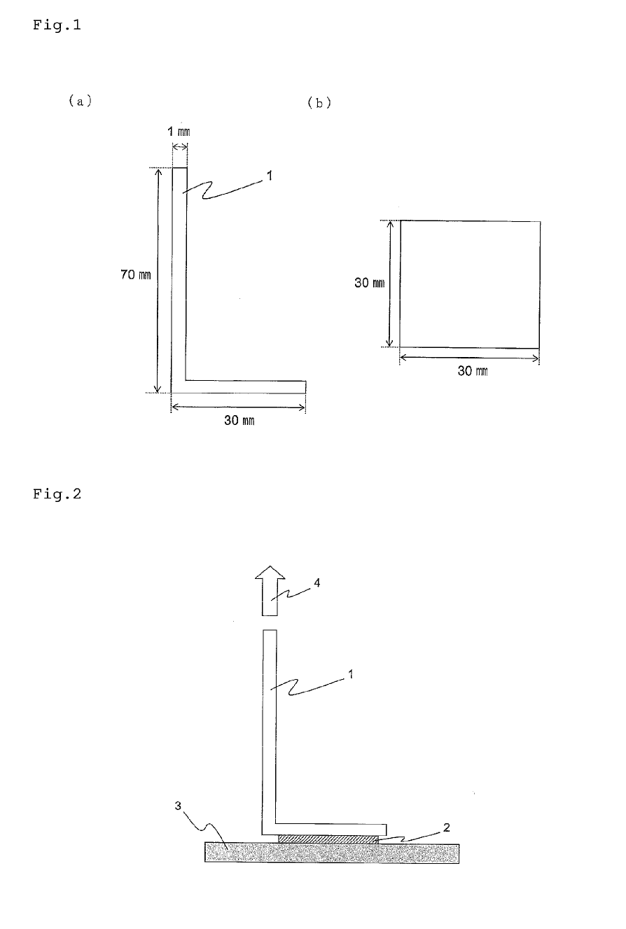

The radiation-curable pressure-sensitive adhesive layer (20 mm×20 mm) is bonded to the center (FIG. 1(b)) of the short side of an L-shaped adherend 1 (SUS plate) as shown in FIG. 1. Thereafter, as shown in FIG. 2, a pressure-sensitive adhesive surface opposite to the side to which the L-shaped adherend 1 of a radiation-curable pressure-sensitive adhesive layer 2 is bonded is bonded to an acrylic plate 3.

After bonding the radiation-curable pressure-sensitive adhesive layer 2 to the acrylic plate 3, the laminate is allowed to stand at 23° C. for 30 minutes, and the L-shaped adherend 1 is peeled off afterwards at a rate of 10 mm/minute in a peeling direction of 90° (direction 4 in FIG. 2) and an adhesive strength (resistance strength) (unit: N/(20 mm×20 mm)) to the acrylic plate 3 at that time is measured.

In the measurement of the adhesive strength and peeling adhesive strength according to the invention, the measurement is carried out using a common plastic acrylic plate as an adherend, but the adherend of the radiation-curable pressure-sensitive adhesive layer of the invention is not limited to such an acrylic plate. As mentioned later, the effect of the invention can be exhibited even by using, as an adherend, a polarizing plate, glass, or surface-treated material thereof other than the plastic plate such as acrylic plate and the like.

The radiation-curable pressure-sensitive adhesive used in the invention is not particularly limited, but, for example, a pressure-sensitive adhesive containing a base polymer and a polyfunctional monomer, wherein compatibility between the base polymer and the polyfunctional monomer is low to the extent not to impair the transparency, is preferable because it can exhibit such an adhesive strength as mentioned above. Since the compatibility between the base polymer and the polyfunctional monomer is low to the extent not to impair the transparency, the polyfunctional monomer in the radiation-curable pressure-sensitive adhesive layer before radiation curing is unevenly distributed in the vicinity of the surface of the radiation-curable pressure-sensitive adhesive layer to form an adhesion inhibitory layer. Thus, the adhesive strength is reduced and the reworkability becomes excellent. On the other hand, after radiation curing, the polyfunctional monomer distributed in the vicinity of the surface is crosslinked to improve the adhesive strength, which makes it possible to impart excellent adhesion reliance.

Examples of the base polymer may include, but are not particularly limited to, (meth)acryl-based polymers, urethane-based polymers, polyester-based polymers, silicone-based polymers, rubber-based polymers such as polyisoprene, polybutadiene, styrene-isoprene-styrene triblock copolymer (SIS), styrene-isobutylene-styrene triblock copolymer (SIBS), and the like. Among them, (meth)acryl-based polymers are preferred from the viewpoint of the compatibility with the polyfunctional monomer described later.

Examples of the (meth)acryl-based polymer include, but are not particularly limited to, (meth)acryl-based polymers obtained by polymerizing a monomer component containing an alkyl (meth)acrylate having an alkyl group of 4 to 22 carbon atoms at the ester end. It should be noted that the alkyl (meth)acrylate includes alkyl acrylate and/or alkyl methacrylate, and the term including “(meth)” is used as the same meaning in the invention.

A linear or branched alkyl group may be used as the alkyl group of 4 to 22 carbon atoms, but a branched alkyl group is preferred.

Examples of the alkyl (meth)acrylate having a linear alkyl group of 4 to 22 carbon atoms at the ester end include n-butyl (meth)acrylate, n-pentyl (meth)acrylate, n-hexyl (meth)acrylate, n-heptyl (meth)acrylate, n-octyl (meth)acrylate, n-nonyl (meth)acrylate, n-decyl (meth)acrylate, n-undecyl (meth)acrylate, n-dodecyl (meth)acrylate, n-tridecyl (meth)acrylate, n-tetradecyl (meth)acrylate, n-pentadecyl (meth)acrylate, n-hexadecyl (meth)acrylate, n-heptadecyl (meth)acrylate, n-octadecyl (meth)acrylate, n-nonadecyl (meth)acrylate, n-eicosyl (meth)acrylate, n-heneicosyl (meth)acrylate, n-docosyl (meth)acrylate, and the like. Examples of the alkyl (meth)acrylate having a branched alkyl group of 4 to 22 carbon atoms at the ester end include t-butyl (meth)acrylate, isobutyl (meth)acrylate, isopentyl (meth)acrylate, t-pentyl (meth)acrylate, neopentyl (meth)acrylate, isohexyl (meth)acrylate, isoheptyl (meth)acrylate, 2-ethylhexyl (meth)acrylate, isooctyl (meth)acrylate, isononyl (meth)acrylate, isodecyl (meth)acrylate, 2-propylheptyl (meth)acrylate, isoundecyl (meth)acrylate, isododecyl (meth)acrylate, isotridecyl (meth)acrylate, isomyristyl (meth)acrylate, isopentadecyl (meth)acrylate, isohexadecyl (meth)acrylate, isoheptadecyl (meth)acrylate, isostearyl (meth)acrylate, isononadecyl (meth)acrylate, isoheneicosyl (meth)acrylate, isodocosyl (meth)acrylate, and the like. Any of these (meth)acrylates may be used alone or in combination of two or more. Among them, n-butyl (meth)acrylate, n-dodecyl (meth)acrylate, 2-ethylhexyl (meth)acrylate, isostearyl (meth)acrylate, isooctyl (meth)acrylate, and isononyl (meth)acrylate are particularly preferred.

The content of the alkyl (meth)acrylate having an alkyl group of 4 to 22 carbon atoms at the ester end is preferably 40 to 99% by weight and more preferably 50 to 95% by weight, based on the total weight of the monomer component used to form the (meth)acryl-based polymer. If the content is 40% by weight or less, the pressure-sensitive adhesive properties after radiation curing may be inferior and if the content is 99% by weight or more, the pressure-sensitive adhesive properties and the adhesion reliance after radiation curing may be inferior.

In addition, the monomer component used to form the (meth)acryl-based polymer contains preferably an alkyl (meth)acrylate having an alkyl group of 4 to 18 carbon atoms, more preferably an alkyl (meth)acrylate having an alkyl group of 8 to 18 carbon atoms, and furthermore preferably an alkyl (meth)acrylate having a branched alkyl group of 8 to 18 carbon atoms, from the viewpoint of lowering the dielectric constant. By lowering the dielectric constant of the pressure-sensitive adhesive layer, improvements in response speed and sensitivity of the touch panel may be expected.

Further, in the invention, if the monomer component contains the alky (meth)acrylate having a branched alkyl group of 8 to 18 carbon atoms, the content thereof is preferably 70% by weight or more and more preferably 70 to 90% by weight, based on the total weight of the monomer component used to form the (meth)acryl-based polymer. In the invention, it is preferable that the monomer component contains 70% by weight or more of the alky (meth)acrylate having a branched alkyl group of 8 to 18 carbon atoms, from the viewpoint of pressure-sensitive adhesive properties before and after radiation curing and low dielectric constant.

A cyclic nitrogen-containing monomer can be used as the monomer component. As the cyclic nitrogen-containing monomer, any monomer having a cyclic nitrogen-containing structure and an unsaturated double bond-containing polymerizable functional group such as a (meth)acryloyl group or a vinyl group may be used without restriction. As the cyclic nitrogen-containing structure, those having a nitrogen atom in the ring structure are preferred. Examples of the cyclic nitrogen-containing monomer include lactam-based vinyl monomers (e.g., N-vinylpyrrolidone, N-vinyl-∈-caprolactam, methylvinylpyrrolidone, etc.); and vinyl-based monomers having nitrogen-containing heterocycles (e.g., vinylpyridine, vinylpiperidone, vinylpyrimidine, vinylpiperazine, vinylpyrazine, vinylpyrrole, vinylimidazole, vinyloxazole, vinylmorpholine, etc.). Examples thereof further include (meth)acrylic monomers containing heterocycles such as morpholine ring, piperidine ring, pyrrolidine ring, and piperazine ring, and specifically include N-acryloylmorpholine, N-acryloylpiperidine, N-methacryloylpiperidine, N-acryloylpyrrolidine, and the like. Among the cyclic nitrogen-containing monomers, lactam-based vinyl monomers are preferable and N-vinylpyrrolidone is more preferable.

The content of the cyclic nitrogen-containing monomer is preferably 25% by weight or less, more preferably 5 to 25% by weight, furthermore preferably 5 to 20% by weight, and particularly preferably 5 to 15% by weight, based on the total weight of the monomer component used to form the (meth)acryl-based polymer.

The monomer component used to form the (meth)acryl-based polymer according to the invention may further include at least one functional group-containing monomer selected from a carboxyl group-containing monomer, a hydroxyl group-containing monomer, and a cyclic ether group-containing monomer.

Any monomer having a carboxyl group and an unsaturated double bond-containing polymerizable functional group such as a (meth)acryloyl group or a vinyl group may be used without restriction as the carboxyl group-containing monomer. Examples of the carboxyl group-containing monomer include (meth)acrylic acid, carboxyethyl (meth)acrylate, carboxypentyl (meth)acrylate, itaconic acid, maleic acid, fumaric acid, crotonic acid, and isocrotonic acid. These may be used alone or in any combination. Itaconic acid or maleic acid can be used in the form of an anhydride. Among these, acrylic acid and methacrylic acid are preferred. It is possible to optionally use a carboxyl group-containing monomer as the monomer component used in the production of the (meth)acryl-based polymer for use in the invention; however, it is not necessary to use a carboxyl group-containing monomer. A pressure-sensitive adhesive containing a (meth)acryl-based polymer obtained from a monomer component not containing a carboxyl group-containing monomer can form a pressure-sensitive adhesive layer that is reduced in metal corrosion due to the carboxyl group and can be used suitably for optical applications, and the like.

Any monomer having a hydroxyl group and an unsaturated double bond-containing polymerizable functional group such as a (meth)acryloyl group or a vinyl group may be used without restriction as the hydroxyl group-containing monomer. Examples of the hydroxyl group-containing monomer include hydroxyalkyl (meth)acrylate such as 2-hydroxyethyl (meth)acrylate, 2-hydroxypropyl (meth)acrylate, 2-hydroxybutyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, or 12-hydroxylauryl (meth)acrylate; and (hydroxyalkylcycloalkyl)alkyl (meth)acrylate such as (4-hydroxymethylcyclohexyl)methyl (meth)acrylate. Other examples include hydroxyethyl(meth)acrylamide, allyl alcohol, 2-hydroxyethyl vinyl ether, 4-hydroxybutyl vinyl ether, and diethylene glycol monovinyl ether. These may be used alone or in any combination. Among them, hydroxyalkyl (meth)acrylate is preferred, 2-hydroxyethyl (meth)acrylate and 4-hydroxybutyl (meth)acrylate are particularly preferred.

Any monomer having a cyclic ether group such as an epoxy group or an oxetane group and an unsaturated double bond-containing polymerizable functional group such as a (meth)acryloyl group or a vinyl group may be used without restriction as the cyclic ether group-containing monomer. Examples of the epoxy group-containing monomer include glycidyl (meth)acrylate, 3,4-epoxycyclohexylmethyl (meth)acrylate, and 4-hydroxybutyl(meth)acrylate glycidyl ether. Examples of the oxetane group-containing monomer include 3-oxetanylmethyl (meth)acrylate, 3-methyl-oxetanylmethyl (meth)acrylate, 3-ethyl-oxetanylmethyl (meth)acrylate, 3-butyl-oxetanylmethyl (meth)acrylate, and 3-hexyl-oxetanylmethyl (meth)acrylate. These monomers may be used alone or in any combination.

In the invention, the content of the functional group-containing monomer is preferably from 1% by weight to 25% by weight, more preferably from 4% by weight to 22% by weight, based on the total weight of the monomer component used to form the (meth)acryl-based polymer. The content of the functional group-containing monomer is preferably 1% by weight or more, more preferably 4% by weight or more so that adhesive strength and cohesive strength can be increased. If the content of the functional group-containing monomer is too high, a hard pressure-sensitive adhesive layer with a lower adhesive strength may be formed, and the pressure-sensitive adhesive may have too high a viscosity or may form a gel. Thus, the content of the functional group-containing monomer is preferably 25% by weight or less based on the total weight of the monomer component used to form the (meth)acryl-based polymer.

The monomer component used to form the (meth)acryl-based polymer may further include a copolymerizable monomer other than the cyclic nitrogen-containing monomer and the functional group-containing monomer. For example, a copolymerizable monomer other than those described above may be an alkyl (meth)acrylate represented by the formula CH₂═C(R¹)COOR², wherein R¹ represents hydrogen or a methyl group, and R² represents a substituted or unsubstituted alkyl group of 1 to 3 carbon atoms or a cycloalkyl group of 3 to 9 carbon atoms.

The substituted or unsubstituted alkyl group of 1 to 3 carbon atoms represented by R² represents a linear or branched alkyl group and a cycloalkyl group of 3 to 9 carbon atoms. The substituted alkyl group preferably has an aryl group of 3 to 8 carbon atoms or an aryloxy group of 3 to 8 carbon atoms as a substituent. The aryl group is preferably, but not limited to, a phenyl group.

Examples of the monomer represented by CH₂═C(R¹)COOR² include methyl (meth)acrylate, ethyl (meth)acrylate, phenoxyethyl (meth)acrylate, benzyl (meth)acrylate, cyclohexyl (meth)acrylate, 3,3,5-trimethyl cyclohexyl (meth)acrylate, and isobornyl (meth)acrylate. These monomers may be used alone or in any combination.

In the invention, the content of the (meth)acrylate represented by CH₂═C(R¹) COOR² is preferably 50% by weight or less, more preferably 30% by weight or less, based on the total weight of the monomer component used to form the (meth)acryl-based polymer.

Other copolymerizable monomers that may also be used include vinyl monomers such as vinyl acetate, vinyl propionate; styrene, α-methylstyrene; glycol acrylic ester monomers such as polyethylene glycol (meth)acrylate, polypropylene glycol (meth)acrylate, methoxyethylene glycol (meth)acrylate, and methoxypolypropylene glycol (meth)acrylate; and acrylate ester monomers such as tetrahydrofurfuryl (meth)acrylate, fluoro(meth)acrylate, silicone (meth)acrylate, and 2-methoxyethyl acrylate; amide group-containing monomers, amino group-containing monomers, imide group-containing monomers, N-acryloyl morpholine, and vinyl ether monomers. Cyclic structure-containing monomers such as terpene (meth)acrylate and dicyclopentanyl (meth)acrylate may also be used as copolymerizable monomers.

Besides the above, a silicon atom-containing silane monomer may be exemplified as the copolymerizable monomer. Examples of the silane monomers include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

The monomer component used to form the (meth)acryl-based polymer in the invention may contain a polyfunctional monomer as needed in addition to the monofunctional monomer exemplified above, in order to adjust the cohesive strength of the pressure-sensitive adhesive.

The polyfunctional monomer is a monomer having at least two polymerizable functional groups with an unsaturated double bond such as (meth)acryloyl group or vinyl group, and examples thereof include ester compounds of a polyhydric alcohol with (meth)acrylic acid (e.g., (poly)ethylene glycol di(meth)acrylate, (poly)propylene glycol di(meth)acrylate, (poly)tetramethylene glycol di(meth)acrylate, neopentyl glycol di(meth)acrylate, pentaerythritol di(meth)acrylate, pentaerythritol tri(meth)acrylate, pentaerythritol tetra(meth)acrylate, dipentaerythritol hexa(meth)acrylate, 1,2-ethyleneglycol di(meth)acrylate, 1,6-hexanediol di(meth)acrylate, 1,12-dodecanediol di(meth)acrylate, trimethylolpropane tri(meth)acrylate, tetramethylolmethane tri(meth)acrylate, ethoxylated bisphenol A di(meth)acrylate, ethoxylated pentaerythritol tetra(meth)acrylate, etc.); trimethylolpropane ethylene oxide-modified triacrylate (trimethylolpropane EO-modified triacrylate), trimethylolpropane propylene oxide-modified triacrylate (trimethylolpropane PO-modified triacrylate), allyl (meth)acrylate, vinyl (meth)acrylate, divinylbenzene, epoxy acrylate, polyester acrylate, urethane acrylate, butanediol di(meth)acrylate, hexanediol di(meth)acrylate, and the like. Among them, trimethylolpropane tri(meth)acrylate, hexanediol di(meth)acrylate, and dipentaerythritol hexa(meth)acrylate can be preferably used. The polyfunctional monomer can be used alone or in combination of two or more.

The content of the polyfunctional monomer used differs depending on the molecular weight or number of functional groups of the monomer, but is preferably 3% by weight or less, more preferably 2% by weight or less, and furthermore preferably 1% by weight or less, based on the total weight of the monomer component used to form the (meth)acryl-based polymer. If the content of the polyfunctional monomer exceeds 3% by weight, for example, there may be cases where cohesive strength of the pressure-sensitive adhesive becomes higher too much and as a result, the adhesive strength is reduced.

Further, the monomer component used in the invention may also include optional components other than the above, but, in that case, the content thereof is preferably 10% by weight or less based on the total weight of the monomer component used to form the (meth)acryl-based polymer.

For the production of the (meth)acryl-based polymer, any appropriate method may be selected from known production methods such as solution polymerization, bulk polymerization, emulsion polymerization, and various radical polymerization methods. The resulting (meth)acryl-based polymer may be any type of copolymer such as a random copolymer, a block copolymer and a graft copolymer.

Any appropriate polymerization initiator, chain transfer agent, emulsifying agent and so on may be selected and used for radical polymerization. The weight average molecular weight of the (meth)acryl-based polymer may be controlled by the reaction conditions including the amount of addition of the polymerization initiator or the chain transfer agent. The amount of the addition may be controlled as appropriate depending on the type of these materials.

For example, in a solution polymerization process, for example, ethyl acetate, toluene or the like is used as a polymerization solvent. Ina specific solution polymerization process, for example, the reaction is performed under a stream of inert gas such as nitrogen at a temperature of about 50 to about 70° C. for about 5 to about 30 hours in the presence of a polymerization initiator.

Examples of the thermal polymerization initiator used for the solution polymerization process include, but are not limited to, azo initiators such as 2,2′-azobisisobutyronitrile, 2,2′-azobis-2-methylbutyronitrile, 2,2′-azobis(2-methylpropionic acid)dimethyl, 4,4′-azobis-4-cyanovaleric acid, azobisisovaleronitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydra to (VA-057, manufactured by Wako Pure Chemical Industries, Ltd.); persulfates such as potassium persulfate and ammonium per sulfate; peroxide initiators such as di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butylperoxyisobutylate, 1,1-di(tert-hexylperoxy)cyclohexane, tert-butylhydroperoxide, and hydrogen peroxide; and redox system initiators of a combination of a peroxide and a reducing agent, such as a combination of a persulfate and sodium hydrogen sulfite and a combination of a peroxide and sodium ascorbate.

One of the above polymerization initiators may be used alone, or two or more thereof may be used in a mixture. The total content of the polymerization initiator is preferably from about 0.005 to 1 part by weight, more preferably from about 0.02 to about 0.5 parts by weight, based on 100 parts by total weight of the monomer component.

For example, when 2,2′-azobisisobutyronitrile is used as a polymerization initiator for the production of the (meth)acryl-based polymer with the above weight average molecular weight, the polymerization initiator is preferably used in a content of from about 0.06 to about 0.3 parts by weight, more preferably of from about 0.08 to about 0.2 parts by weight, based on 100 parts by total weight of the monomer component.

Examples of the chain transfer agent include lauryl mercaptan, glycidyl mercaptan, mercaptoacetic acid, 2-mercaptoethanol, thioglycolic acid, methy thioglycolate, ethyl thioglycolate, butyl thioglycolate, isooctyl thioglycolate, 2-ethylhexyl thioglycolate, α-thioglycerol, 2,3-dimercapto-1-propanol, cyclohexanethiol, 1-octanethiol and tert-nonyl mercaptan. One of these chain transfer agents may be used alone, or two or more thereof may be used in a mixture. The total content of the chain transfer agent is preferably about 0.1 parts by weight or less, based on 100 parts by total weight of the monomer component.

Examples of the emulsifier used in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone, or two or more thereof may be used in combination.

The emulsifier may be a reactive emulsifier. Examples of such an emulsifier having an introduced radical-polymerizable functional group with a carbon-carbon double bond such as a propenyl group and an allyl ether group include Aqualon HS-10, HS-20, KH-10, BC-05, BC-10, and BC-20 (each manufactured by Dai-ichi Kogyo Seiyaku Co., Ltd.) and Adekaria Soap SE10N (manufactured by ADEKA COORPORATION). The reactive emulsifier is preferred, because after polymerization, it can be incorporated into a polymer chain to improve water resistance. Based on 100 parts by total weight of the monomer component, the emulsifier is preferably used in a content of 5 parts by weight or less, more preferably of 0.3 to 5 parts by weight, furthermore preferably of 0.5 to 1 part by weight, in view of polymerization stability or mechanical stability.

In the invention, the (meth)acryl-based polymer preferably has a weight average molecular weight of 400,000 to 2,500,000, more preferably 500,000 to 2,200,000. When the weight average molecular weight is more than 400,000, the pressure-sensitive adhesive layer can have satisfactory durability and can have a cohesive strength small enough to suppress adhesive residue. On the other hand, if the weight average molecular weight is more than 2,500,000, bonding ability or adhesive strength may tend to be lower. In this case, the pressure-sensitive adhesive may form a solution with too high a viscosity, which may be difficult to apply. As used herein, the term “weight average molecular weight” refers to a polystyrene-equivalent weight average molecular weight, which is determined using GPC (gel permeation chromatography).

### <Measurement of Weight Average Molecular Weight>

The weight average molecular weight of the obtained (meth)acryl-based polymer was measured by GPC (gel permeation chromatography) as follows. The polymer sample was dissolved in tetrahydrofuran to form a 0.1% by weight solution. After allowed to stand overnight, the solution was filtered through a 0.45 μm membrane filter, and the filtrate was used for the measurement.

Analyzer: HLC-8120GPC manufactured by TOSOH CORPORATION

### Column: TSK gel GMH-H(S)

Column size: 7.8 mmφ×30 cm
Eluent: tetrahydrofuran (concentration 0.1% by weight)
Flow rate: 0.5 ml/minute
Detector: differential refractometer (RI)
Column temperature: 40° C.
Injection volume: 100 μl
Eluent: tetrahydrofuran
Detector: differential refractometer
Standard sample: polystyrene

The polyfunctional monomer to be added to the radiation-curable pressure-sensitive adhesive may be a polyfunctional monomer having at least two radically polymerizable functional groups with a carbon-carbon double bond in the molecule and can be appropriately selected from the viewpoint of the compatibility with the base polymer. Examples of the polyfunctional monomer may include polyfunctional monomers that can be contained in the monomer component described above.

Further, in the case where the base polymer is a (meth)acryl-based polymer, a polyfunctional monomer having at least two radically polymerizable functional groups having a carbon-carbon double bond and an ether bond in the molecule (hereinafter, may be referred to as a polyfunctional monomer having an ether bond in some cases) is preferable from the viewpoint of the compatibility. Here, the ether bond means a “carbon-oxygen-carbon” bond.

Examples of the polyfunctional monomer having an ether bond may include (poly)ethylene glycol di(meth)acrylate, (poly) propylene glycol di(meth)acrylate, (poly)tetramethylene glycol di(meth)acrylate, ethoxylated bisphenol A di(meth)acrylate, ethoxylated pentaerythritol tetra(meth)acrylate, di(meth)acrylate of hydroxypivalic acid neopentylglycol ∈-caprolactone adduct, trimethylolpropane EO-modified triacrylate (M-360, manufactured by TOAGOSEI CO., LTD.), trimethylolpropane PO-modified triacrylate (M-321, manufactured by TOAGOSEI CO., LTD.), and the like. The polyfunctional monomer having an ether bond may be used alone or in combination of two or more. Among them, (poly)ethylene glycol di(meth)acrylate, (poly)propylene glycol di(meth)acrylate, (poly)tetramethylene glycol di(meth)acrylate, and di(meth)acrylate of hydroxypivalic acid neopentylglycol ∈-caprolactone adduct are preferred, and (poly)ethylene glycol di(meth)acrylate, (poly)propylene glycol di(meth)acrylate, (poly)tetramethylene glycol di(meth)acrylate, and trimethylolpropane EO-modified triacrylate (M-360, manufactured by TOAGOSEI CO., LTD.) are more preferable.

The polyfunctional monomer (in particular, the polyfunctional monomer having an ether bond) suitably has a molecular weight in the range of about 100 to about 10000.

The content of the polyfunctional monomer (in particular, the polyfunctional monomer having an ether bond) is preferably 0.1 to 50 parts by weight, more preferably 5 to 40 parts by weight, and furthermore preferably 10 to 40 parts by weight based on 100 parts by weight of the base polymer. If the content of the polyfunctional monomer is 0.1 parts by weight or more, the reworkability is excellent, and if the content is 50 parts by weight or less, the transparency is excellent.

In addition, the polyfunctional monomer (in particular, the polyfunctional monomer having an ether bond) has a viscosity at 25° C. of preferably less than 2.0 Pa·s, more preferably 1.0 Pa·s or less, and furthermore preferably 0.5 Pa·s or less. The viscosity of less than 2.0 Pa·s at 25° C. is preferable from the viewpoint of the compatibility with the base polymer. Further, when the melting point of the polyfunctional monomer is high and the polyfunctional monomer is solid at 25° C., the viscosity at 40° C. may be preferably within the above range.

As mentioned above, in the invention, a combination of the (meth)acryl-based polymer and the polyfunctional monomer having an ether bond is preferable. Since the compatibility between the polyfunctional monomer having an ether bond and the (meth)acryl-based polymer is low to the extent not to impair the transparency, the polyfunctional monomer having an ether bond in the radiation-curable pressure-sensitive adhesive layer before radiation curing is unevenly distributed in the vicinity of the surface of the radiation-curable pressure-sensitive adhesive layer to form an adhesion inhibitory layer. Thus, the adhesive strength is reduced and the reworkability becomes excellent. After radiation curing, the polyfunctional monomer having an ether bond distributed in the vicinity of the surface is crosslinked to improve the adhesive strength, which makes it possible to impart excellent adhesion reliance.

Although a pressure-sensitive adhesive layer is formed from the radiation-curable pressure-sensitive adhesive, the pressure-sensitive adhesive layer can be cured by radiation irradiation with electron beam, UV, etc. after bonding it to an adherend. When the radiation polymerization is carried out with an electron beam, it is not particularly necessary to allow the radiation-curable pressure-sensitive adhesive to contain a photopolymerization initiator, but when the radiation polymerization is carried out by UV polymerization, a photopolymerization initiator may be contained in the radiation-curable pressure-sensitive adhesive. The photopolymerization initiator may be used alone or in combination of two or more.

The photopolymerization initiator is not particularly limited as long as it can initiate photopolymerization, and photopolymerization initiators that are usually used can be employed. Examples thereof that can be used include benzoin ether-based photopolymerization initiator, acetophenone-based photopolymerization initiator, α-ketol-based photopolymerization initiator, aromatic sulfonyl chloride-based photopolymerization initiator, photoactive oxime-based photopolymerization initiator, benzoin-based photopolymerization initiator, benzyl-based photopolymerization initiator, benzophenone-based photopolymerization initiator, ketal-based photopolymerization initiator, thioxanthone-based photopolymerization initiator, acylphosphine oxide-based photopolymerization initiator, and the like.

Specific examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one (trade name: IRGACURE 651, manufactured by BASF), and the like. Examples of the acetophenone-based photopolymerization initiator include 1-hydroxycyclohexyl phenyl ketone (trade name: IRGACURE 184, manufactured by BASF), 4-phenoxydichloroacetophenone, 4-t-butyl-dichloroacetophenone, 1-[4-(2-hydroxyethoxy)-phenyl]-2-hydroxy-2-methyl-1-propan-1-one (trade name: IRGACURE 2959, manufactured by BASF), 2-hydroxy-2-methyl-1-phenyl-propan-1-one (trade name: DAROCUR 1173, manufactured by BASF), methoxyacetophenone, and the like. Examples of the α-ketol-based photopolymerization initiator include 2-methyl-2-hydroxypropiophenone, 1-[4-(2-hydroxyethyl)-phenyl]-2-hydroxy-2-methylpropan-1-on e, and the like. Examples of the aromatic sulfonyl chloride-based photopolymerization initiator include 2-naphthalene sulfonyl chloride and the like. Examples of the photoactive oxime-based photopolymerization initiator include 1-phenyl-1,2-propanedione-2-(O-ethoxycarbonyl)-oxime, and the like.

Examples of the benzoin-based photopolymerization initiator include benzoin and the like. Examples of the benzyl-based photopolymerization initiator include benzyl and the like. Examples of the benzophenone-based photopolymerization initiators include benzophenone, benzoylbenzoic acid, 3,3′-dimethyl-4-methoxybenzophenone, polyvinyl benzophenone, α-hydroxycyclohexyl phenyl ketone, and the like. Examples of the ketal-based photopolymerization initiator include benzyl dimethyl ketal and the like. Examples of the thioxanthone-based photopolymerization initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, dodecylthioxanthone and the like.

Examples of the acylphosphine oxide-based photopolymerization initiator include bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropan-1-yl)phosphine oxide, bis(2-methoxybenzoyl)(1-methylpropan-1-yl)phosphine oxide, bis(2,6-diethoxybenzoyl)(2-methylpropan-1-yl)phosphine oxide, bis(2,6-diethoxybenzoyl)(1-methylpropan-1-yl)phosphine oxide, bis(2,6-dibutoxybenzoyl)(2-methylpropan-1-yl)phosphine oxide, bis(2,4-dimethoxybenzoyl)(2-methylpropan-1-yl)phosphine oxide, bis(2,4,6-trimethylbenzoyl)(2,4-dipentoxyphenyl)phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, tri(2-methylbenzoyl)phosphine oxide, and the like.

The content of the polymerization initiator is not particularly limited, but is preferably 0.01 to 5 parts by weight, more preferably 0.05 to 3 parts by weight, furthermore preferably 0.05 to 1.5 parts by weight, and particularly preferably 0.1 to 1 part by weight, based on 100 parts by weight of the (meth)acryl-based polymer.

If the content of the photopolymerization initiator is below 0.01 parts by weight, there may be cases where the curing reaction is insufficient. If the content of the photopolymerization initiator used exceeds 5 parts by weight, the ultraviolet ray may not reach the inside of the pressure-sensitive adhesive layer because of UV absorption by the photopolymerization initiator. In this case, the curing reaction is decreased to cause a reduction in cohesive strength of the formed pressure-sensitive adhesive layer. Thus, there may be cases where when the pressure-sensitive adhesive layer is peeled off from the adherend, part of the pressure-sensitive adhesive layer remains in the adherend and accordingly such an adherend cannot be reused.

The radiation-curable pressure-sensitive adhesive of the invention may contain a crosslinking agent. Examples of the crosslinking agents include an isocyanate crosslinking agent, an epoxy crosslinking agent, a silicone crosslinking agent, an oxazoline crosslinking agent, an aziridine crosslinking agent, a silane crosslinking agent, an alkyl etherified melamine crosslinking agent, and a metallic chelate crosslinking agent. Such crosslinking agents may be used alone or in combination of two or more. An isocyanate crosslinking agent or an epoxy crosslinking agent is preferably used as the crosslinking agent.

These crosslinking agents may be used alone or in a mixture of two or more. The total content of the crosslinking agent (s) is preferably in the range of 0.005 to 5 parts by weight based on 100 parts by weight of the (meth)acryl-based polymer. The content of the crosslinking agent (s) is more preferably from 0.005 to 4 parts by weight, even more preferably from 0.01 to 3 parts by weight.

The term “isocyanate crosslinking agent” refers to a compound having two or more isocyanate groups (which may include functional groups that are temporarily protected with an isocyanate blocking agent or by oligomerization and are convertible to isocyanate groups) per molecule.

Isocyanate crosslinking agents include aromatic isocyanates such as tolylene diisocyanate and xylene diisocyanate, alicyclic isocyanates such as isophorone diisocyanate, and aliphatic isocyanates such as hexamethylene diisocyanate.

More specifically, examples of isocyanate crosslinking agents include lower aliphatic polyisocyanates such as butylene diisocyanate and hexamethylene diisocyanate; alicyclic isocyanates such as cyclopentylene diisocyanate, cyclohexylene diisocyanate, and isophorone diisocyanate; aromatic diisocyanates such as 2,4-tolylene diisocyanate, 4,4′-diphenylmethane diisocyanate, xylylene diisocyanate, and polymethylene polyphenyl isocyanate; isocyanate adducts such as a trimethylolpropane-tolylene diisocyanate trimer adduct (trade name: CORONATE L, manufactured by NIPPON POLYURETHANE INDUSTRY CO., LTD.), a trimethylolpropane-hexamethylene diisocyanate trimer adduct (trade name: CORONATE HL, manufactured by NIPPON POLYURETHANE INDUSTRY CO., LTD.), and an isocyanurate of hexamethylene diisocyanate (trade name: CORONATE HX, manufactured by NIPPON POLYURETHANE INDUSTRY CO., LTD.); a trimethylolpropane adduct of xylylene diisocyanate (trade name: D110N, manufactured by Mitsui Chemicals, Inc.) and a trimethylolpropane adduct of hexamethylene diisocyanate (trade name: D160N, manufactured by Mitsui Chemicals, Inc.); polyether polyisocyanate and polyester polyisocyanate; adducts thereof with various polyols; and polyisocyanates polyfunctionalized with an isocyanurate bond, a biuret bond, an allophanate bond, or the like. In particular, aliphatic isocyanates are preferably used because of their high reaction speed.

These isocyanate crosslinking agents may be used alone or in a mixture of two or more. The total content of the isocyanate crosslinking agent(s) is preferably from 0.005 to 5 parts by weight, more preferably from 0.005 to 4 parts by weight, even more preferably from 0.01 to 3 parts by weight, based on 100 parts by weight of the (meth)acryl-based polymer. The content may be appropriately determined taking into account cohesive strength, the ability to prevent delamination in a durability test, or other properties.

When an aqueous dispersion of a modified (meth)acryl-based polymer produced by emulsion polymerization is used, the isocyanate crosslinking agent does not have to be used. If necessary, however, a blocked isocyanate crosslinking agent may also be used in such a case, because the isocyanate crosslinking agent itself can easily react with water.

The term “epoxy crosslinking agent” refers to a polyfunctional epoxy compound having two or more epoxy groups per molecule. Examples of the epoxy crosslinking agent include bisphenol A, epichlorohydrin-type epoxy resin, ethylene glycol diglycidyl ether, N,N,N′,N′-tetraglycidyl-m-xylenediamine, diglycidylaniline, N,N-diamino glycidyl amine, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, glycerine diglycidyl ether, glycerine triglycidyl ether, polyglycerol polyglycidyl ether, sorbitan polyglycidyl ether, trimethylolpropane polyglycidyl ether, diglycidyl adipate, diglycidyl o-phthalate, triglycidyl tris(2-hydroxyethyl)isocyanurate, resorcin diglycidyl ether, bisphenol-S diglycidyl ether, and epoxy resins having two or more epoxy groups in the molecule. The epoxy crosslinking agent may also be a commercially available product such as TETRAD-C (trade name) or TETRAD-X (trade name) manufactured by MITSUBISHI GAS CHEMICAL COMPANY, INC.

These epoxy crosslinking agents may be used alone or in a mixture of two or more. The total content of the epoxy crosslinking agent(s) is preferably from 0.005 to 5 parts by weight, more preferably from 0.01 to 4 parts by weight, even more preferably from 0.01 to 3 parts by weight, based on 100 parts by weight of the (meth)acryl-based polymer. The content may be appropriately determined taking into account cohesive strength, the ability to prevent delamination in a durability test, or other properties.

As the crosslinking agent, a polyfunctional metal chelate may also be used in combination with an organic crosslinking agent. Examples of the polyfunctional metal chelate may include a polyvalent metal and an organic compound that is covalently or coordinately bonded to the metal. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include alkyl esters, alcohol compounds, carboxylic acid compounds, ether compounds, and ketone compounds.

The radiation-curable pressure-sensitive adhesive of the invention may contain a (meth)acryl-based oligomer for improving adhesive strength. The (meth)acryl-based oligomer is preferably a polymer having a Tg higher than that of the (meth)acryl-based polymer according to the invention and having a weight average molecular weight lower than that of the (meth)acryl-based polymer according to the invention. Such a (meth)acryl-based oligomer functions as a tackifying resin and is advantageous in increasing adhesive strength without raising dielectric constant.

The (meth)acryl-based oligomer may preferably have a Tg of about 0° C. to 300° C., more preferably about 20° C. to 300° C., even more preferably about 40° C. to 300° C. If the Tg is lower than 0° C., the cohesive strength of the pressure-sensitive adhesive layer may decrease at room temperature or higher so that holding performance or tackiness at high temperature may decrease. The Tg of the (meth)acryl-based oligomer is also a theoretical value calculated from the Fox equation.

The (meth)acryl-based oligomer may have a weight average molecular weight of 1,000 to less than 30,000, preferably 1,500 to less than 20,000, more preferably 2,000 to less than 10,000. If the oligomer has a weight average molecular weight of 30,000 or more, the effect of improving adhesive strength cannot be sufficiently obtained in some cases. The oligomer with a weight average molecular weight of less than 1,000 may lower the adhesive strength or holding performance because of its relatively low molecular weight. In the invention, the weight average molecular weight of the (meth)acryl-based oligomer can be determined as a polystyrene-equivalent weight average molecular weight by GPC method. More specifically, the weight average molecular weight can be determined using HPLC 8020 with two TSKgel GMH-H (20) columns manufactured by TOSOH CORPORATION under the conditions of a solvent of tetrahydrofuran and a flow rate of about 0.5 ml/minute.

Examples of monomers that may be used to form the (meth)acryl-based oligomer include alkyl (meth)acrylate such as methyl (meth)acrylate, ethyl (meth)acrylate, propyl (meth)acrylate, isopropyl (meth)acrylate, butyl (meth)acrylate, isobutyl (meth)acrylate, sec-butyl (meth)acrylate, tert-butyl (meth)acrylate, pentyl (meth)acrylate, isopentyl (meth)acrylate, hexyl (meth)acrylate, 2-ethylhexyl (meth)acrylate, heptyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, or dodecyl (meth)acrylate; an ester of (meth)acrylic acid and an alicyclic alcohol, such as cyclohexyl (meth)acrylate, isobornyl (meth)acrylate or dicyclopentanyl (meth)acrylate; aryl (meth)acrylate such as phenyl (meth)acrylate or benzyl (meth)acrylate; and a (meth)acrylate derived from a terpene compound derivative alcohol. These (meth)acrylates may be used alone or in combination of two or more.

The (meth)acryl-based oligomer preferably contains, as a monomer unit, an acrylic monomer having a relatively bulky structure, typified by an alkyl (meth)acrylate whose alkyl group has a branched structure, such as isobutyl (meth)acrylate or tert-butyl (meth)acrylate; an ester of (meth)acrylic acid and an alicyclic alcohol, such as cyclohexyl (meth)acrylate, isobornyl (meth)acrylate or dicyclopentanyl (meth)acrylate; or aryl (meth)acrylate such as phenyl (meth)acrylate or benzyl (meth)acrylate, or any other cyclic structure-containing (meth)acrylate. The use of a (meth)acryl-based oligomer with such a bulky structure can further improve the tackiness of the pressure-sensitive adhesive layer. In terms of bulkiness, cyclic structure-containing oligomers are highly effective, and oligomers having two or more rings are more effective. When ultraviolet (UV) light is used in the process of synthesizing the (meth)acryl-based oligomer or forming the pressure-sensitive adhesive layer, a saturated oligomer is preferred because such an oligomer is less likely to inhibit polymerization, and an alkyl (meth)acrylate whose alkyl group has a branched structure or an ester of an alicyclic alcohol and (meth)acrylic acid is preferably used as a monomer to form the (meth)acryl-based oligomer.

From these points of view, preferred examples of the (meth)acryl-based oligomer include a copolymer of cyclohexyl methacrylate (CHMA) and isobutyl methacrylate (IBMA), a copolymer of cyclohexyl methacrylate (CHMA) and isobornyl methacrylate (IBXMA), a copolymer of cyclohexyl methacrylate (CHMA) and acryloyl morpholine (ACMO), a copolymer of cyclohexyl methacrylate (CHMA) and diethylacrylamide (DEAA), a copolymer of 1-adamanthyl acrylate (ADA) and methyl methacrylate (MMA), a copolymer of dicyclopentanyl methacrylate (DCPMA) and isobornyl methacrylate (IBXMA), a copolymer of dicyclopentanyl methacrylate (DCPMA) and methyl methacrylate (MMA), and a homopolymer of each of dicyclopentanyl methacrylate (DCPMA), cyclohexyl methacrylate (CHMA), isobornyl methacrylate (IBXMA), isobornyl acrylate (IBXA), dicyclopentanyl acrylate (DCPA), 1-adamanthyl methacrylate (ADMA), and 1-adamanthyl acrylate (ADA). In particular, an oligomer composed mainly of CHMA is preferred.

In the radiation-curable pressure-sensitive adhesive used in the invention, the content of the (meth)acryl-based oligomer is preferably, but not limited to, 70 parts by weight or less, more preferably from 1 to 70 parts by weight, even more preferably from 2 to 50 parts by weight, still more preferably from 3 to 40 parts by weight, based on 100 parts by weight of the (meth)acryl-based polymer. If the content of the (meth)acryl-based oligomer is more than 70 parts by weight, a problem may occur such as an increase in elastic modulus or a decrease in tackiness at low temperature. Adding 1 part by weight or more of the (meth)acryl-based oligomer is effective in improving adhesive strength.

The radiation-curable pressure-sensitive adhesive used in the invention may further contain a silane coupling agent for improving water resistance at the interface between the pressure-sensitive adhesive layer and a hydrophilic adherend, such as glass, bonded thereto. The content of the silane coupling agent is preferably 1 part by weight or less, more preferably from 0.01 to 1 part by weight, even more preferably from 0.02 to 0.6 parts by weight, based on 100 parts by weight of the (meth)acryl-based polymer. If the content of the silane coupling agent is too high, the adhesive may have a higher adhesive strength to glass so that it may be less removable from glass. If the content of the silane coupling agent is too low, the durability of the adhesive may undesirably decrease.

Examples of silane coupling agent include epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-(2-aminoethyl)-3-aminopropylmethyldimethoxysilane, 3-triethoxysilyl-N-(1,3-dimethylbutylidene)propylamine and N-phenyl-γ-aminopropyltrimethoxysilane; (meth)acrylic group-containing silane coupling agents such as 3-acryloxypropyltrimethoxysilane and 3-methacryloxypropyltriethoxysilane; and isocyanate group-containing silane coupling agents such as 3-isocyanatepropyltriethoxysilane.

The radiation-curable pressure-sensitive adhesive used in the invention may also contain any other known additive. For example, a powder such as a colorant and a pigment, a dye, a surfactant, a plasticizer, a tackifier, a surface lubricant, a leveling agent, a softening agent, an antioxidant, an age resister, a light stabilizer, an ultraviolet absorbing agent, a polymerization inhibitor, an inorganic or organic filler, a metal powder, or a particle- or foil-shaped material may be added as appropriate depending on the intended use. The content of these additives can be appropriately determined if it is within the range that does not impair the effect of the invention, and it is, for example, preferably 10 parts by weight or less based on 100 parts by weight of the (meth)acryl-based polymer.

Examples of the tackifier include petroleum-based resins, terpene-based resins, and hydrogenation products thereof. The tackifier used in the radiation-curable pressure-sensitive adhesive of the invention is preferably a hydrogenated tackifier that does not inhibit the curing by radiation such as ultraviolet rays. The tackifier can improve the adhering strength of the radiation-curable pressure-sensitive adhesive of the invention likewise the (meth)acryl-based oligomer. Further, the tackifier may be used in the same proportion as the (meth)acryl-based oligomer.

The radiation-curable pressure-sensitive adhesive layer of the invention is formed from the radiation-curable pressure-sensitive adhesive. The thickness of the pressure-sensitive adhesive layer is typically, but not limited to, from about 1 to 400 μm, preferably from 50 to 400 μm, more preferably from 50 to 300 μm, further preferably from 50 to 200 μm.

The radiation-curable pressure-sensitive adhesive layer of the invention may be cured after being bonded to an adherend. When radiation irradiation is carried out by UV irradiation, it is possible to use a high-pressure mercury lamp, a low-pressure mercury lamp, a metal halide lamp or the like. Usually, the amount of ultraviolet irradiation is about 1000 to 10000 mJ/cm².

Further, the gel fraction of the radiation-curable pressure-sensitive adhesive layer of the invention before radiation curing is preferably 5 to 60% by weight, more preferably 10 to 55% by weight, and furthermore preferably 15 to 50% by weight.

In addition, the gel fraction after radiation curing is preferably 40 to 95% by weight, more preferably 44 to 85% by weight, and furthermore preferably 45 to 75% by weight. Further, curing conditions by radiation irradiation and measurement method in accordance with the gel fraction are based on the description of Examples.

It is preferable that the value of the gel fraction after radiation curing is equivalent to or more than the value before radiation curing. The value after radiation curing is preferably 1.2 to 10 times the value before radiation curing, more preferably 1.2 to 8 times the value before radiation curing, and furthermore preferably 1.2 to 5 times the value before radiation curing.

The gel fraction of the radiation-curable pressure-sensitive adhesive layer of the invention can be controlled by adjusting the proportion of the polyfunctional monomer having an ether bond contained in the radiation-curable pressure-sensitive adhesive while taking into consideration of the effects of the treatment temperature and treatment time of the curing. Further, when the pressure-sensitive adhesive contains a crosslinking agent, the gel fraction can be controlled by adjusting the content of the crosslinking agent added in total while sufficiently taking into consideration of the effects of treatment temperature and treatment time of the crosslinking. It is to be noted that when the gel fraction of the pressure-sensitive adhesive layer after curing is small, the cohesive strength may become poor, and when the gel fraction of the pressure-sensitive adhesive layer after curing is too large, the adhering strength may become poor.

The radiation-curable pressure-sensitive adhesive layer of the invention preferably has a haze value of 2% or less when having a thickness of 100 μm. The pressure-sensitive adhesive layer with a haze value of 2% or less can satisfy the requirements for transparency when it is used on optical members. The haze value is preferably from 0 to 1.5%, more preferably from 0 to 1%. A haze value of 2% or less is a satisfactory level for optical applications. If the haze value is more than 2%, cloudiness may occur, which is not preferred for optical film.

### 2. Radiation-Curable Pressure-Sensitive Adhesive Sheet

The radiation-curable pressure-sensitive adhesive sheet of the invention has a feature of having a support and the radiation-curable pressure-sensitive adhesive layer of the invention formed on at least one side of the support.

For example, the pressure-sensitive adhesive sheet of the invention may be formed by a method including applying the radiation-curable pressure-sensitive adhesive to a support, removing the polymerization solvent and so on by drying to form a pressure-sensitive adhesive sheet. Before the radiation-curable pressure-sensitive adhesive is applied, appropriately at least one solvent other than the polymerization solvent may be added to the radiation-curable pressure-sensitive adhesive.

Various methods may be used to apply the radiation-curable pressure-sensitive adhesive. Specific examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like.

The heat drying temperature is preferably from 40° C. to 200° C., more preferably from 50° C. to 180° C., in particular, preferably from 70° C. to 170° C. Setting the heating temperature within the above range makes it possible to obtain a pressure-sensitive adhesive layer having good adhesive properties. The drying time may be any appropriate period of time. The drying time is preferably from 5 seconds to 20 minutes, more preferably from 5 seconds to 10 minutes, in particular, preferably from 10 seconds to 5 minutes.

For example, a release-treated sheet may be used as the support. A silicone release liner is preferably used as the release-treated sheet.

In the pressure-sensitive adhesive sheet include the layer pressure-sensitive adhesive layer formed on the release-treated sheet, when the pressure-sensitive adhesive layer is exposed, the pressure-sensitive adhesive layer may be protected with the release-treated sheet (a separator) before practical use. The release-treated sheet is peeled off before actual use.

Examples of the material for forming the separator include a plastic film such as a polyethylene, polypropylene, polyethylene terephthalate, or polyester film, a porous material such as paper, cloth and nonwoven fabric, and an appropriate thin material such as a net, a foamed sheet, a metal foil, and a laminate thereof. In particular, a plastic film is preferably used, because of its good surface smoothness.

The plastic film may be any film capable of protecting the pressure-sensitive adhesive layer, and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the separator is generally from about 5 to about 200 μm, preferably from about 5 to about 100 μm. If necessary, the separator may be treated with a release agent such as a silicone, fluorine, long-chain alkyl, or fatty acid amide release agent, or may be subjected to release and antifouling treatment with silica powder or to antistatic treatment of coating type, kneading and mixing type, vapor-deposition type, or the like. In particular, if the surface of the separator is appropriately subjected to release treatment such as silicone treatment, long-chain alkyl treatment, and fluorine treatment, the releasability from the pressure-sensitive adhesive layer can be further increased.

The radiation-curable pressure-sensitive adhesive layer and radiation-curable pressure-sensitive adhesive sheet of the invention can be applied to various members each of which serves as an adherend. Further, such an adhesive layer and a sheet can be used preferably for formation of a laminate in which a first member and a second member are bonded together.

The radiation-curable pressure-sensitive adhesive layer and the pressure-sensitive adhesive sheet of the invention are suitable for use on optical members, and particularly in optical applications, they are preferably used and bonded to metal thin layers or metal electrodes. Metal thin layers include thin layers of metal, metal oxide, or a mixture of metal and metal oxide, and examples of metal thin layers include, but are not limited to, thin layers of ITO (indium tin oxide), ZnO, SnO, and CTO (cadmium tin oxide). The thickness of metal thin layers is typically, but not limited to, about 10 to 200 nm. Usually, for example, a metal thin layer such as an ITO layer is provided on a transparent plastic film substrate such as a polyethylene terephthalate film (specifically, a PET film) to form a transparent conductive film for use. When the pressure-sensitive adhesive sheet of the invention is bonded to a metal thin layer, the surface of the pressure-sensitive adhesive layer is preferably used as a bonding surface to the metal thin layer.

The metal electrodes may be made of metal, metal oxide, or a mixture of metal and metal oxide, and examples include, but are not limited to, ITO, silver, copper, and CNT (carbon nanotube) electrodes.

A specific example of the use of the pressure-sensitive adhesive sheet of the invention is a touch panel-forming pressure-sensitive adhesive sheet, which is used in the manufacture of a touch panel. For example, the touch panel-forming pressure-sensitive adhesive sheet is used in the manufacture of a capacitance touch panel, where it is used to bond a transparent conductive film having a metal thin layer such as an ITO layer to a poly(methyl methacrylate) (PMMA) resin sheet, a hard-coated film, a glass lens, or any other material. Applications of the touch panel include, but are not limited to, cellular phones, tablet computers, and personal digital assistances.

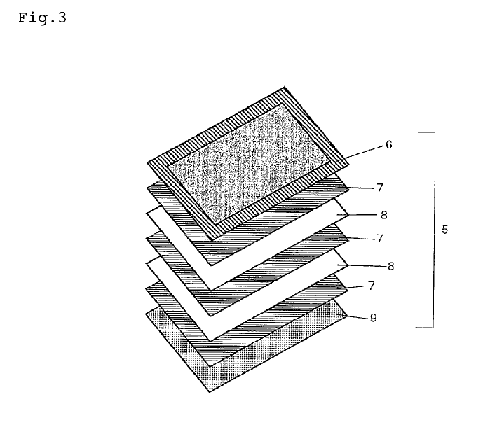

FIG. 3 shows a more specific example of the use of the pressure-sensitive adhesive layer or the pressure-sensitive adhesive sheet of the invention, which is an example of a capacitance touch panel. FIG. 3 shows a capacitance touch panel 5 including a decorative panel 6, pressure-sensitive adhesive layers or pressure-sensitive adhesive sheets 7, ITO films 8, and a hard coated film 9. The decorative panel 6 is preferably a glass plate or a transparent acrylic plate (PMMA plate). The decorative panel 6 is subjected to printing on cover glass and the like, and may have a printing step. Each ITO films 8 preferably includes a glass sheet or a transparent plastic film (specifically, a PET film) and an ITO layer provided thereon. The hard coated film 9 is preferably a hard coated transparent plastic film such as a hard coated PET film. The capacitance touch panel 5 having the pressure-sensitive adhesive layer or the pressure-sensitive adhesive sheet of the invention can be made thinner and more stable in operation. The capacitance touch panel 5 also has a good appearance and good visibility.

An optical member may be used as the support of the pressure-sensitive adhesive sheet of the invention. The pressure-sensitive adhesive layer can be formed by a process including applying the pressure-sensitive adhesive directly to an optical member and drying the adhesive to remove the polymerization solvent and the like, so that the pressure-sensitive adhesive layer is formed on the optical member. Alternatively, the pressure-sensitive adhesive layer may be formed on a release-treated separator and then transferred to an optical member as needed to form a pressure-sensitive adhesive optical member.

The release-treated sheet used in the preparation of the pressure-sensitive adhesive optical member of the invention may be used by itself as a separator for the pressure-sensitive adhesive optical member, so that the process can be simplified.

The process for forming the pressure-sensitive adhesive layer for the pressure-sensitive adhesive optical member may further include forming an anchor layer on the surface of the optical member or performing any adhesion-facilitating treatment such as a corona treatment or a plasma treatment before forming the pressure-sensitive adhesive layer. The surface of the pressure-sensitive adhesive layer may also be subjected to an adhesion-facilitating treatment.

The pressure-sensitive adhesive optical member of the invention may be used as a pressure-sensitive adhesive layer-carrying transparent conductive film, which is produced using a transparent conductive film as an optical member. The transparent conductive film includes a transparent plastic film substrate and a transparent conductive thin layer that is formed of a metal thin layer such as the ITO layer on one surface of the substrate. The pressure-sensitive adhesive layer of the invention is provided on the other surface of the transparent plastic film substrate. The transparent conductive thin layer may be provided on the transparent plastic film substrate with an undercoat layer interposed therebetween. Two or more undercoat layers may be provided. An oligomer migration-preventing layer may be provided between the transparent plastic film substrate and the pressure-sensitive adhesive layer.

The transparent plastic film substrate to be used may be, but not limited to, various transparent plastic films. The plastic film is generally formed of a monolayer film. Examples of the material for the transparent plastic film substrate include polyester resins such as polyethylene terephthalate and polyethylene naphthalate, acetate resins, polyethersulfone resins, polycarbonate resins, polyamide resins, polyimide resins, polyolefin resins, (meth)acrylic resins, polyvinyl chloride resins, polyvinylidene chloride resins, polystyrene resins, polyvinyl alcohol resins, polyarylate resins, and polyphenylene sulfide resins. In particular, polyester resins, polyimide resins, and polyethersulfone resins are preferred. The film substrate preferably has a thickness of 15 to 200 μm.

The surface of the film substrate may be previously subject to sputtering, corona discharge treatment, flame treatment, ultraviolet irradiation, electron beam irradiation, chemical treatment, etching treatment such as oxidation, or undercoating treatment such that the adhesion of the transparent conductive thin layer or the undercoat layer formed thereon to the transparent plastic film substrate can be improved. If necessary, the film substrate may also be subjected to dust removing or cleaning by solvent cleaning, ultrasonic cleaning or the like, before the transparent conductive thin layer or the undercoat layer is formed.

The material and thickness of the transparent conductive thin layer are not restricted and may be those described for the metal thin layer. The undercoat layer may be made of an inorganic material, an organic material or a mixture of an inorganic material and an organic material. Examples of the inorganic material include NaF (1.3), Na₃AlF₆ (1.35), LiF (1.36), MgF₂ (1.38), CaF₂ (1.4), BaF₂ (1.3), SiO₂ (1.46), LaF₃ (1.55), CeF₃ (1.63), and Al₂O₃ (1.63), wherein each number inside the parentheses is the refractive index of each material. In particular, SiO₂, MgF₂, Al₂O₃, or the like is preferably used. In particular, SiO₂ is preferred. Besides the above, a complex oxide containing about 10 to about 40 parts by weight of cerium oxide and about 0 to about 20 parts by weight of tin oxide based on 100 parts by weight of the indium oxide may also be used.

Examples of the organic material include acrylic resins, urethane resins, melamine resins, alkyd resins, siloxane polymers, and organosilane condensates. At least one of these organic materials may be used. In particular, a thermosetting resin including a mixture composed of a melamine resin, an alkyd resin and an organosilane condensate is preferably used as the organic material.

The thickness of the undercoat layer is generally, but not limited to, from about 1 to about 300 nm, preferably from about 5 to about 300 nm, in view of optical design and the effect of preventing the release of an oligomer from the film substrate.

The pressure-sensitive adhesive layer-carrying transparent conductive film can be used to form various devices such as touch panels and liquid crystal display devices. In particular, the pressure-sensitive adhesive layer-carrying transparent conductive film is preferably used as a touch panel-forming electrode sheet. The touch panel is suitable for use in different types of detection (such as resistive and capacitance types).

A capacitance touch panel usually includes a transparent conductive film that has a transparent conductive thin layer in a specific pattern and is formed over the surface of a display unit. The pressure-sensitive adhesive layer-carrying transparent conductive film is a laminate in which the pressure-sensitive adhesive layer and the patterned transparent conductive thin layer are appropriately stacked facing each other.

The pressure-sensitive adhesive optical member of the invention may be used as a pressure-sensitive adhesive layer-carrying optical film, which is produced using an image display-forming optical film as the optical member.

The optical film may be of any type for use in forming image display devices such as liquid crystal display devices and organic electro-luminescent (EL) display devices. For example, a polarizing plate is exemplified as the optical film. A polarizing plate including a polarizer and a transparent protective film provided on one or both sides of the polarizer is generally used.

A polarizer is not limited especially but various kinds of polarizer may be used. As a polarizer, for example, a film that is uniaxially stretched after having dichromatic substances, such as iodine and dichromatic dye, absorbed to hydrophilic polymer films, such as polyvinyl alcohol type film, partially formalized polyvinyl alcohol type film, and ethylene-vinyl acetate copolymer type partially saponified film; poly-ene type alignment films, such as dehydrated polyvinyl alcohol and dehydrochlorinated polyvinyl chloride, etc. may be mentioned. In these, a polyvinyl alcohol type film on which dichromatic materials such as iodine, is absorbed and aligned after stretched is suitably used. Although thickness of polarizer is not especially limited, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions containing boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions containing boric acid and/or potassium iodide, and in water bath.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% by weight, particularly preferably from 70 to 97% by weight. If the content of the thermoplastic resin in the transparent protective film is 50% by weight or less, high transparency and other properties inherent in the thermoplastic resin can fail to be sufficiently exhibited.

Further an optical film of the invention may be used as other optical layers, such as a reflective plate, a transflective plate, a retardation plate (a half wavelength plate and a quarter wavelength plate included), an optical compensation film, a viewing angle compensation film and a brightness enhancement film, which may be used for formation of a liquid crystal display device etc. These are used in practice as an optical film, or as one layer or two layers or more of optical layers laminated with polarizing plate.

Although an optical film with the above described optical layer laminated to the polarizing plate may be formed by a method in which laminating is separately carried out sequentially in manufacturing process of a liquid crystal display device etc., an optical film in a form of being laminated beforehand has an outstanding advantage that it has excellent stability in quality and assembly workability, etc., and thus manufacturing processes ability of a liquid crystal display device etc. may be raised. Proper adhesion means, such as a pressure-sensitive adhesive layer, may be used for laminating. On the occasion of adhesion of the above described polarizing plate and other optical layers, the optical axis may be set as a suitable configuration angle according to the target retardation characteristics etc.

The pressure-sensitive adhesive layer-carrying optical film of the invention is preferably used to form various types of image display devices such as liquid crystal display devices. Liquid crystal display devices may be formed according to conventional techniques. Specifically, liquid crystal display devices are generally formed by appropriately assembling a liquid crystal cell and the pressure-sensitive adhesive layer-carrying optical film and optionally other component such as a lighting system and incorporating a driving circuit according to any conventional technique, except that the pressure-sensitive layer-carrying adhesive optical film of the invention is used. Any type of liquid crystal cell may also be used such as a TN type, an STN type, a n type a VA type and IPS type.

Suitable liquid crystal display devices, such as liquid crystal display device with which the pressure-sensitive adhesive layer-carrying optical film has been located at one side or both sides of the liquid crystal cell, and with which a backlight or a reflective plate is used for a lighting system may be manufactured. In this case, the optical film according to the invention may be installed in one side or both sides of the liquid crystal cell. When installing the optical films in both sides, they may be of the same type or of different type. Furthermore, in assembling a liquid crystal display device, suitable parts, such as diffusion plate, anti-glare layer, antireflection film, protective plate, prism array, lens array sheet, optical diffusion plate, and backlight, may be installed in suitable position in one layer or two or more layers.

### EXAMPLES

The present invention will be specifically described below by way of Examples, but the invention is not limited thereto. In each Example, both “part” and “%” are based on weight.

### Example 1

### Preparation of (Meth)Acryl-Based Polymer

A four-neck flask equipped with a stirring wing, a thermometer, a nitrogen gas introducing tube, and a condenser was charged with 63 parts by weight of 2-ethylhexyl acrylate (2EHA), 15 parts by weight of N-vinylpyrrolidone (NVP), 9 parts by weight of methyl methacrylate (MMA), 13 parts by weight of 2-hydroxyethyl acrylate (HEA), and 0.2 parts by weight of 2,2′-azobisisobutyronitrile (AIBN) as a thermal polymerization initiator, together with 177.8 parts by weight of ethyl acetate. The mixture was stirred at 23° C. for 1 hour under a nitrogen atmosphere and allowed to react at 65° C. for 5 hours and then at 70° C. for 2 hours, thereby to prepare a (meth)acryl-based polymer solution.

### <Preparation of Radiation-Curable Pressure-Sensitive Adhesive>

Then, to the (meth)acryl-based polymer solution obtained above were added 10 parts by weight of polyethylene glycol (#600) diacrylate (trade name: A-600, manufactured by Shin-Nakamura Chemical Co., Ltd.) as a polyfunctional monomer having an ether bond, 0.1 parts by weight of a photopolymerization initiator (trade name: IRGACURE 184, manufactured by BASF), 0.3 parts by weight of 3-glycidoxypropyl trimethoxysilane (trade name: KBM403, manufactured by Shin-Etsu Chemical Co., Ltd.) as a silane coupling agent, and 0.1 parts by weight of a trimethylolpropane adduct of xylylene diisocyanate (trade name: D110N, manufactured by Mitsui Chemicals, Inc.) as a crosslinking agent, based on 100 parts by weight of the solid content of the polymer. Subsequently, the mixture was uniformly mixed to prepare a radiation-curable pressure-sensitive adhesive solution.

### <Formation of Radiation-Curable Pressure-Sensitive Adhesive Layer: Production of Pressure-Sensitive Adhesive Sheet>

A radiation-curable pressure-sensitive adhesive layer having a thickness of 55 μm was formed by applying the radiation-curable pressure-sensitive adhesive solution obtained above to the peel off-treated surface of a 50 μm thick polyester film of which one side had been peel off-treated with silicone and heating the coated surface at 100° C. for 3 minutes. Then, the 50 μm thick polyester film of which one side had been peel off-treated with silicone was bonded to the coated surface of the radiation-curable pressure-sensitive adhesive layer such that the peel off-treated surface of the film faced the coat layer, thereby to produce a pressure-sensitive adhesive sheet.

### Example 2

A pressure-sensitive adhesive sheet was produced in the same manner as in Example 1, except that polyethylene glycol (#1000) diacrylate (trade name: A-1000, manufactured by Shin-Nakamura Chemical Co., Ltd.) was used in place of the polyethylene glycol (#600) diacrylate (trade name: A-600, manufactured by Shin-Nakamura Chemical Co., Ltd.) in the <Preparation of Radiation-Curable Pressure-Sensitive Adhesive> of Example 1.

### Example 3

A pressure-sensitive adhesive sheet was produced in the same manner as in Example 1, except that the kind and composition ratio of the monomers used in the <Preparation of (Meth)acryl-Based Polymer> of Example 1 were changed as shown in Table 1, and that the crosslinking agent used in the <Preparation of Radiation-Curable Pressure-Sensitive Adhesive> was changed from 0.1 parts by weight of the trimethylolpropane adduct of xylylene diisocyanate (trade name: D110N, manufactured by Mitsui Chemicals, Inc.) to 0.03 parts by weight of epoxy-based crosslinking agent (trade name: TETRAD-C, manufactured by MITSUBISHI GAS CHEMICAL COMPANY, INC.).

### Example 4

### Preparation of (Meth)Acryl-Based Polymer

A four-neck flask equipped with a stirring wing, a thermometer, a nitrogen gas introducing tube, and a condenser was charged with 32 parts by weight of 2-ethylhexyl acrylate (2EHA), 48 parts by weight of isostearyl acrylate (ISTA) (trade name: ISTA, manufactured by Osaka Organic Chemical Industry Ltd.), 10 parts by weight of N-vinylpyrrolidone (NVP), 10 parts by weight of 4-hydroxybutyl acrylate (4HBA), and 0.1 parts by weight of 2,2′-azobisisobutyronitrile (AIBN) as a thermal polymerization initiator, together with 150 parts by weight of ethyl acetate. The mixture was then stirred at 23° C. for 1 hour under a nitrogen atmosphere and allowed to react at 58° C. for 4 hours and then at 70° C. for 2 hours, thereby to prepare a (meth)acryl-based polymer solution.

### <Preparation of Radiation-Curable Pressure-Sensitive Adhesive>

Then, to the (meth)acryl-based polymer solution obtained above were added 20 parts by weight of polypropylene glycol (#700) diacrylate (trade name: APG-700, manufactured by Shin-Nakamura Chemical Co., Ltd.) as a radiation-curable polyfunctional monomer component, 0.1 parts by weight of a photopolymerization initiator (trade name: IRGACURE 184, manufactured by BASF), 0.3 parts by weight of 3-glycidoxypropyl trimethoxysilane (trade name: KBM403, manufactured by Shin-Etsu Chemical Co., Ltd.) as a silane coupling agent, and 0.05 parts by weight of a trimethylolpropane adduct of xylylene diisocyanate (trade name: D110N, manufactured by Mitsui Chemicals, Inc.) as a crosslinking agent, based on 100 parts by weight of the solid content of the polymer. Subsequently, the mixture was uniformly mixed to prepare a radiation-curable pressure-sensitive adhesive solution.

### <Formation of Radiation-Curable Pressure-Sensitive Adhesive Layer: Production of Pressure-Sensitive Adhesive Sheet>

A radiation-curable pressure-sensitive adhesive layer having a thickness of 55 μm was formed by applying the radiation-curable pressure-sensitive adhesive solution obtained above to the peel off-treated surface of a 50 μm thick polyester film of which one side had been peel off-treated with silicone and heating the coated surface at 100° C. for 3 minutes. Then, the 50 μm thick polyester film of which one side had been peel off-treated with silicone was bonded to the coated surface of the radiation-curable pressure-sensitive adhesive layer such that the peel off-treated surface of the film faced the coat layer, thereby to produce a pressure-sensitive adhesive sheet.

### Examples 5 to 11

A pressure-sensitive adhesive sheet was prepared in the same procedure as in Example 4, except that the kind and composition ratio of the monomers used in the <Preparation of (Meth)acryl-Based Polymer> of Example 4, and the kind of the polyfunctional monomer having an ether bond and the content of the crosslinking agent used in the <Preparation of Radiation-Curable Pressure-Sensitive Adhesive> were changed as shown in Table 1.

### Comparative Example 1

### Preparation of (Meth)Acryl-Based Polymer

A four-neck flask equipped with a stirring wing, a thermometer, a nitrogen gas introducing tube, and a condenser was charged with 90 parts by weight of 2-ethylhexyl acrylate (2EHA), 10 parts by weight of acrylic acid (AA), 0.35 parts by weight of 4-methacroyloxybenzophenone (MBP), and 0.4 parts by weight of 2,2′-azobis(2,4-valeronitrile) (trade name: V-65, manufactured by Wako Pure Chemical Industries, Ltd.) as a thermal polymerization initiator, together with 150 parts by weight of MEK. The mixture was stirred at 23° C. for 1 hour under a nitrogen atmosphere and allowed to react at 50° C. for 4 hours and then at 60° C. for 2 hours, thereby to prepare a (meth)acryl-based polymer solution.

### <Preparation of Radiation-Curable Pressure-Sensitive Adhesive>

Subsequently, to the (meth)acryl-based polymer solution obtained above was added 0.3 parts by weight of 3-glycidoxypropyl trimethoxysilane (trade name: KBM403, manufactured by Shin-Etsu Chemical Co., Ltd.) as a silane coupling agent based on 100 parts by weight of the solid content of the polymer, and the mixture was then uniformly mixed to prepare a radiation-curable pressure-sensitive adhesive solution.

### <Formation of Radiation-Curable Pressure-Sensitive Adhesive Layer: Production of Pressure-Sensitive Adhesive Sheet>

A radiation-curable pressure-sensitive adhesive layer having a thickness of 55 μm was formed by applying the solution of a radiation-curable pressure-sensitive adhesive obtained above to the peel off-treated surface of a 50 μm thick polyester film of which one side had been peel off-treated with silicone and heating the coated surface at 100° C. for 3 minutes. Then, the 50 μm thick polyester film of which one side had been peel off-treated with silicone was bonded to the coated surface of the radiation-curable pressure-sensitive adhesive layer such that the peel off-treated surface of the film faced the coat layer, thereby to produce a pressure-sensitive adhesive sheet.

### Comparative Examples 2 and 3

A pressure-sensitive adhesive sheet was prepared in the same procedure as in Example 4, except that the kind of the polyfunctional monomer having an ether bond and the added content of the crosslinking agent in the <Preparation of Radiation-Curable Pressure-Sensitive Adhesive> of Example 4 were changed as shown in Table 1.

TABLE 1

| | | | | | | | | | | Polyfunctional monomer | | | | | Si | Photopoly- |
|---|---|---|---|---|---|---|---|---|---|---|---|---|---|---|---|---|
| | | | | | | | | | | | | Viscosity | Crosslinking | | coupling | merization |
| | (Meth) acryl-based polymer | | | | | | | | | | | (Pa · s) | agent | | agent | initiator |
| | BA | 2EHA | ISTA | NVP | AA | MMA | HEA | 4HBA | MBP | Kind | Part | (25° C.) | Kind | Part | Part | Part |
| Example 1 | | 63 | | 15 | | 9 | 13 | | | A-600 | 10 | 0.106 | D110N | 0.1 | 0.3 | 0.1 |
| Example 2 | | 63 | | 15 | | 9 | 13 | | | A-1000 | 10 | 0.1 | D110N | 0.1 | 0.3 | 0.1 |
| | | | | | | | | | | | | (40° C.) | | | | |
| Example 3 | 95 | | | | 5 | | | | | A-600 | 10 | 0.106 | T/C | 0.03 | 0.3 | 0.1 |
| Example 4 | | 32 | 48 | 10 | | | | 10 | | APG-700 | 20 | 0.068 | D110N | 0.05 | 0.3 | 0.1 |
| Example 5 | | 32 | 48 | 10 | | | | 10 | | APG-700 | 40 | 0.068 | D110N | 0.05 | 0.3 | 0.1 |
| Example 6 | | 16 | 64 | 10 | | | | 10 | | APG-700 | 10 | 0.068 | D110N | 0.07 | 0.3 | 0.1 |
| Example 7 | | 10 | 70 | 10 | | | | 10 | | APG-700 | 10 | 0.068 | D110N | 0.07 | 0.3 | 0.1 |
| Example 8 | | | 78 | 10 | | | | 12 | | APG-700 | 10 | 0.068 | D110N | 0.07 | 0.3 | 0.1 |
| Example 9 | | 30 | 50 | 8 | | | | 12 | | A-PTMG65 | 10 | 0.14 | D110N | 0.03 | 0.3 | 0.1 |
| Example 10 | | 30 | 50 | 8 | | | | 12 | | HX-620 | 10 | 0.2-0.3 | D110N | 0.03 | 0.3 | 0.1 |
| Example 11 | | 32 | 48 | 10 | | | | 10 | | M-360 | 10 | 0.65-0.9 | D110N | 0.07 | 0.3 | 0.1 |
| Comparative | | 90 | | | 10 | | | | 0.35 | — | — | | — | — | 0.3 | — |
| Example 1 | | | | | | | | | | | | | | | | |
| Comparative | | 32 | 48 | 10 | | | | 10 | | M-1200 | 10 | 1200-2200 | D110N | 0.03 | 0.3 | 0.1 |
| Example 2 | | | | | | | | | | | | (50° C.) | | | | |
| Comparative | | 32 | 48 | 10 | | | | 10 | | M-6100 | 10 | 2-4.5 | D110N | 0.03 | 0.3 | 0.1 |
| Example 3 | | | | | | | | | | | | | | | | |

The pressure-sensitive adhesive sheets obtained in the Examples and the Comparative Examples were evaluated as described below. Table 2 shows the evaluation results.

### <Measurement of Gel Fraction>

A predetermined amount (initial weight W₁) was sampled from the pressure-sensitive adhesive layer of the pressure-sensitive adhesive sheet. The sample was immersed and stored in an ethyl acetate solution at room temperature for 1 week. The insoluble matter was then taken out and measured for dry weight (W₂). The gel fraction of the sample was determined from the following formula.

Gel fraction (%)=(W₂/W₂)×100 [formula 1]

The gel fraction was measured before radiation irradiation and after radiation irradiation, respectively. The radiation irradiation was carried out under the condition of an ultraviolet irradiation amount of 2500 mJ/cm² using a high-pressure mercury lamp.

### <180° Peeling Adhesive Strength Test>

After one release liner (polyester film) on the pressure-sensitive adhesive sheet obtained in each of Examples and Comparative Examples was peeled off, a polyethylene terephthalate (PET) film having a thickness of 25 μm was bonded to the pressure-sensitive adhesive layer. The obtained sheet was cut into a piece having a width of 20 mm, which was used as a test specimen. In addition, an acrylic plate (ACRYLITE, manufactured by Mitsubishi Rayon Co., Ltd.) having a thickness of 2 mm, which had been cleaned with isopropyl alcohol, was prepared. After the other release liner (polyester film) on the pressure-sensitive adhesive sheet was peeled off, the pressure-sensitive adhesive surface of the sheet was bonded to the acrylic plate by reciprocating a 2-kg roller.

The pressure-sensitive adhesive layer was bonded to the acrylic plate, and then allowed to stand at 23° C. for 30 minutes (before curing). In addition, the pressure-sensitive adhesive layer was bonded to the acrylic plate, subjected to radiation curing at a dose of 3000 mJ/cm², and allowed to stand at 23° C. for 30 minutes (after curing).

Then, each adhesive strength (resistance force) (unit: N/20 mm) of the pressure-sensitive adhesive layer to an adherend before and after radiation curing was measured by peeling off one end of a laminate of the pressure-sensitive adhesive layer and the PET film in a peeling direction of 180° at a rate of 300 mm/minute. The case where the adhesive strength before curing was 1.0 N/20 mm or less was evaluated as good (◯), while the case where the adhesive strength before curing was more than 1.0 N/20 mm was evaluated as poor (X). The case where the adhesive strength after curing was 3.0 N/20 mm or more was evaluated as good (◯), while the case where the adhesive strength after curing was less than 3.0 N/20 mm was evaluated as poor (X).

### <Peeling Adhesive Strength Test>

The pressure-sensitive adhesive sheet obtained in each Examples and Comparative Examples was cut into a piece of 20 mm×20 mm. After one release liner (polyester film) was peeled off, the sheet was bonded to the center (FIG. 1(b)) of the short side of an L-shaped adherend 1 (SUS plate) shown in FIG. 1, which had been cleaned with toluene, by reciprocating a 2-kg roller. Thereafter, the other release liner (polyester film) was peeled off and the surface of the sheet was bonded to an acrylic plate 3 (trade name: ACRYLITE, manufactured by Mitsubishi Rayon Co., Ltd.), which had been cleaned with toluene, by reciprocating a 2-kg roller.

After the adhesive layer was bonded to the acrylic plate 3, the sheet was allowed to stand at 23° C. for 30 minutes. Then, the L-shaped adherend 1 was peeled off in a peeling direction 4 of 90° at a rate of 10 mm/minute, and the adhesive strength (resistance force) (unit: N) of the pressure-sensitive adhesive layer with respect to the acrylic plate 3 at that time was measured. The case where the adhesive strength was 40.0 N/(20 mm×20 mm) or less was evaluated as good (◯), while the case where the adhesive strength was more than 40.0 N/(20 mm×20 mm) was evaluated as poor (X). The acrylic plate was fixed to the measuring device during the measurement.

TABLE 2

| | | | Adhesive | | |
|---|---|---|---|---|---|
| | Gel fraction | | strength | | Peeling adhesive |
| | (% by weight) | | [N/20 mm] | | strength |
| | Before | After | Before | After | [N/(20 × 20 mm)] |
| | curing | curing | curing | curing | Before curing |
| Example 1 | 20.8 | 45.7 | 0.1 | 10.8 | 7.8 |
| Example 2 | 38.5 | 52.3 | 0.4 | 10.8 | 18.4 |
| Example 3 | 46.4 | 69.5 | 0.5 | 8.3 | 7.8 |
| Example 4 | 18.6 | 56.2 | 0.2 | 10.2 | 28.6 |
| Example 5 | 11.4 | 55.0 | 0.04 | 9.9 | 5.3 |
| Example 6 | 31.2 | 56.1 | 1.0 | 8.6 | 40.0 |
| Example 7 | 31.6 | 54.1 | 0.3 | 9.4 | 35.0 |
| Example 8 | 30.1 | 49.4 | 0.1 | 3.4 | 18.2 |
| Example 9 | 10.7 | 44.9 | 0.4 | 14.9 | 29.0 |
| Example 10 | 24.5 | 61.2 | 0.7 | 13.0 | 25.8 |
| Example 11 | 39.0 | 65.7 | 0.1 | 15.0 | 21.5 |
| Comparative | 2.6 | 31.1 | 18.9 | 11.0 | 44.2 |
| Example 1 | | | | | |
| Comparative | 15.6 | 59.5 | 20.1 | 16.0 | 139.2 |
| Example 2 | | | | | |
| Comparative | 25.1 | 47.1 | 15.8 | 16.5 | 79.6 |
| Example 3 | | | | | |

The abbreviations shown in Table 1 mean as follows, respectively.

BA: Butyl acrylate
2EHA: 2-Ethylhexyl acrylate (manufactured by TOAGOSEI CO., LTD.)
AA: Acrylic acid
ISTA: Isostearyl acrylate (manufactured by Osaka Organic Chemical Industry Ltd.)
NVP: N-Vinyl-2-pyrrolidone (manufactured by Nippon Shokubai Co., Ltd.)
MMA: Methyl methacrylate
HEA: 2-Hydroxyethyl acrylate
4HBA: 4-Hydroxybutyl acrylate

### MBP: 4-Methacryloyloxybenzophenone

A-600: Polyethylene glycol (#600) diacrylate (manufactured by Shin-Nakamura Chemical Co., Ltd.)
A-1000: Polyethylene glycol (#1000) diacrylate (manufactured by Shin-Nakamura Chemical Co., Ltd.)
APG-700: Polypropylene glycol (#700) diacrylate (manufactured by Shin-Nakamura Chemical Co., Ltd.)
A-PTMG65: Polytetramethylene glycol (#650) diacrylate (manufactured by Shin-Nakamura Chemical Co., Ltd.)
HX-620: Di(meth)acrylate of hydroxypivalic acid neopentylglycol ∈-caprolactone adduct (KAYARAD HX-620, manufactured by Nippon Kayaku Co., Ltd.)
M-360: Trimethylolpropane EO-modified triacrylate (manufactured by TOAGOSEI CO., LTD.)
M-1200: Urethane acrylate (manufactured by TOAGOSEI CO., LTD.)
M-6100: Polyester acrylate (manufactured by TOAGOSEI CO., LTD.)
D110N: Trimethylolpropane adduct of xylylene diisocyanate (manufactured by Mitsui Chemicals, Inc.)
T/C: Epoxy-based crosslinking agent (trade name: TETRAD-C, manufactured by MITSUBISHI GAS CHEMICAL COMPANY, INC.).

### DESCRIPTION OF REFERENCE SIGNS

1 L-shaped adherend (SUS plate)
2 Radiation-curable pressure-sensitive adhesive layer
3 Acrylic plate
4 Peeling direction
5 Capacitance touch panel
6 Decorative panel
7 pressure-sensitive adhesive layer or pressure-sensitive adhesive sheet
8 ITO film
9 Hard coated film

What is claimed is:

1. A radiation-curable pressure-sensitive adhesive layer, which has an adhesive strength of 1.0 N/20 mm or less before radiation curing and an adhesive strength of 3.0 N/20 mm or more after radiation curing, and a peeling adhesive strength of 40.0 N/(20 mm×20 mm) or less before radiation curing, with respect to an acrylic plate.

2. The radiation-curable pressure-sensitive adhesive layer according to claim 1, which is formed from a radiation-curable pressure-sensitive adhesive comprising a base polymer and a polyfunctional monomer.

3. The radiation-curable pressure-sensitive adhesive layer according to claim 2, wherein the base polymer is a (meth)acryl-based polymer and the polyfunctional monomer is a polyfunctional monomer having an ether bond and at least two radically polymerizable functional groups with a carbon-carbon double bond in the molecule.

4. The radiation-curable pressure-sensitive adhesive layer according to claim 2, wherein the content of the polyfunctional monomer is 0.1 to 50 parts by weight based on 100 parts by weight of the base polymer.

5. A radiation-curable pressure-sensitive adhesive sheet having a support and the radiation-curable pressure-sensitive adhesive layer according to claim 1 formed on at least one side of the support.

6. The radiation-curable pressure-sensitive adhesive sheet according to claim 5, wherein the support is an optical member and the pressure-sensitive adhesive sheet is a pressure-sensitive adhesive optical member having a pressure-sensitive adhesive layer on at least one side of the optical member.

7. The radiation-curable pressure-sensitive adhesive layer according to claim 3, wherein the content of the polyfunctional monomer is 0.1 to 50 parts by weight based on 100 parts by weight of the base polymer.

8. A radiation-curable pressure-sensitive adhesive sheet having a support and the radiation-curable pressure-sensitive adhesive layer according to claim 2 formed on at least one side of the support.

9. A radiation-curable pressure-sensitive adhesive sheet having a support and the radiation-curable pressure-sensitive adhesive layer according to claim 3 formed on at least one side of the support.

10. A radiation-curable pressure-sensitive adhesive sheet having a support and the radiation-curable pressure-sensitive adhesive layer according to claim 4 formed on at least one side of the support.

11. The radiation-curable pressure-sensitive adhesive sheet according to claim 7, wherein the support is an optical member and the pressure-sensitive adhesive sheet is a pressure-sensitive adhesive optical member having a pressure-sensitive adhesive layer on at least one side of the optical member.

12. The radiation-curable pressure-sensitive adhesive sheet according to claim 8, wherein the support is an optical member and the pressure-sensitive adhesive sheet is a pressure-sensitive adhesive optical member having a pressure-sensitive adhesive layer on at least one side of the optical member.

13. The radiation-curable pressure-sensitive adhesive sheet according to claim 9, wherein the support is an optical member and the pressure-sensitive adhesive sheet is a pressure-sensitive adhesive optical member having a pressure-sensitive adhesive layer on at least one side of the optical member.

14. The radiation-curable pressure-sensitive adhesive sheet according to claim 10, wherein the support is an optical member and the pressure-sensitive adhesive sheet is a pressure-sensitive adhesive optical member having a pressure-sensitive adhesive layer on at least one side of the optical member.
